(19) United States
(12) Patent Application Publication
(10) Pub. No.: US 2009/0103507 A1
(43) Pub. Date: Apr. 23, 2009

(54) Method, Apparatus and Computer Program Product to Provide Enhanced Reverse Link Medium Access Control in a Multi-Carrier Wireless Communications System

(76) Inventors: Jian Gu, Guangdong (CN); Yuan-Joshua Zhu, Beijing (CN)

Correspondence Address: HARRINGTON & SMITH, PC, 4 RESEARCH DRIVE, Suite 202, SHELTON, CT, 06484-6212, US

(21) Appl. No.: 11/887,974

(22) PCT Filed: May 3, 2006
(86) PCT No.: PCT/IB2006/001141

§ 371 Date: Oct. 4, 2007

Related U.S. Application Data
(60) Provisional application No. 60/680,255, filed on May 11, 2005.

(51) Int. Cl. H04B 7/216

(52) U.S. Cl. 370/342

(57) ABSTRACT

A method determines whether information corresponding to one of a number of carriers indicates the one carrier is loaded or unloaded, wherein the carriers are used for transmission of a MAC flow by the access terminal over a reverse link. Responsively, the transmission resource allocation corresponding to the MAC flow for the one carrier is adjusted based on information corresponding to carrier loading for each of the carriers and on information corresponding to reverse link pilot power for each of the carriers. An access terminal includes a function that determines whether the one is loaded or unloaded. Responsively, the function adjusts transmission resource allocation for the MAC flow for the one carrier based on information of carrier loading for each of the carriers and on information of reverse link pilot power for each of the carriers.

### TECHNICAL FIELD

The exemplary and non-limiting embodiments of this invention relate generally to wireless communications systems and method and, more specifically, relate to multi-carrier digital wireless communications systems and methods.

### BACKGROUND

A multiple radio frequency (RF) carrier (Multi-Carrier) system has been proposed to enhance code division multiple access (cdma) system performance in 3GPP2. In general, Multi-Carrier systems have complex forward link (FL, base station to user equipment or Access Terminal (AT)) and reverse link (RL, user equipment to base station) deployments. The forward link and reverse link may be symmetrical or asymmetrical, depending on the application requirements for a given deployment.

An issue that arises is how to best manage the reverse link radio resources for the traffic channel (e.g., Rise over Thermal (ROT) and ratio of Traffic Channel Power to Pilot Power (T2P)).

### BRIEF SUMMARY

In an exemplary embodiment, a method is disclosed that is performed on an access terminal. The method includes determining whether information corresponding to one of a number of carriers indicates the one carrier is loaded or unloaded. The number of carriers is used for transmission of a medium access control (MAC) flow by the access terminal over a reverse link. Responsive to the determining, the method includes adjusting transmission resource allocation corresponding to the MAC flow for the one carrier. The adjusting is based at least in part on information corresponding to carrier loading for each of the number of carriers and on information corresponding to reverse link pilot power for each of the number of carriers.

In another exemplary embodiment, an access terminal is disclosed. The access terminal includes a function operable to determine whether information corresponding to one of a number of carriers indicates the one carrier is loaded or unloaded. The number of carriers is used for transmission of a MAC flow by the access terminal over a reverse link. The function is also operable to adjust, responsive to the determination, transmission resource allocation corresponding to the MAC flow for the one carrier. The adjustment is based at least in part on information corresponding to carrier loading for each of the number of carriers and on information corresponding to reverse link pilot power for each of the number of carriers.

In yet another exemplary embodiment, a computer program product is disclosed that is embodied on a computer readable medium. The computer program product includes program instructions for directing at least one data processor that is part of an access terminal to perform operations. The operations include determining whether information corresponding to one of a number of carriers indicates the one carrier is loaded or unloaded, wherein the number of carriers is used for transmission of a MAC flow by the access terminal over a reverse link. The operations also include adjusting, in response to the determining operation, transmission resource allocation corresponding to the MAC flow for the one carrier. The adjusting operation is based at least in part on information corresponding to carrier loading for each of the number of carriers and on information corresponding to reverse link pilot power for each of the number of carriers.

In a further exemplary embodiment, an access terminal is disclosed that includes means for determining whether information corresponding to one of a number of carriers indicates the one carrier is loaded or unloaded. The number of carriers is used for transmission of a MAC flow by the access terminal over a reverse link. The access terminal also includes means responsive to the determination for adjusting transmission resource allocation corresponding to the MAC flow for the one carrier. The adjusting is based at least in part on information corresponding to carrier loading for each of the number of carriers and on information corresponding to reverse link pilot power for each of the number of carriers.

In an additional exemplary embodiment, an integrated circuit is disclosed including a function operable to determine whether information corresponding to one of a number of carriers indicates the one carrier is loaded or unloaded. The number of carriers is used for transmission of a medium access control (MAC) flow by the access terminal over a reverse link. The function is also operable to adjust, responsive to the determination, transmission resource allocation corresponding to the MAC flow for the one carrier. The adjustment is based at least in part on information corresponding to carrier loading for each of the number of carriers and on information corresponding to reverse link pilot power for each of the number of carriers.

### BRIEF DESCRIPTION OF THE DRAWINGS

In the attached Drawing Figures:

FIG. 1 is a graph that shows exemplary fading over two adjacent carriers with a correlation of 0.5;

FIG. 2 is a block diagram of an AT that includes a reverse traffic channel medium access control (RTCMAC) that operates in accordance with non-limiting embodiments of this invention;

FIG. 3 is a graph of exemplary T2PInflow over a number of sub-frames;

FIG. 4 is a graph of exemplary BucketLevel over a number of sub-frames;

FIG. 5 is a flowchart of an exemplary method for determining that a carrier is loaded and for adjusting transmission resource for the carrier based on the determination;

FIG. 6 is a flowchart of an exemplary method for determining that a carrier is unloaded and for adjusting transmission resource for the carrier based on the determination; and

FIG. 7 is a flowchart of an exemplary method for determining loading for a carrier and for adjusting transmission resource for the carrier based on the determination.

### DETAILED DESCRIPTION

Before proceeding with examples of the disclosed invention, it is beneficial to review some terms and concepts related to the disclosed invention. A concept with importance to a T2P resource is a “bucket”, which is a container of the T2P resource. A rate control algorithm (e.g., as implemented by the RTCMAC 16 in FIG. 2 below) can be considered to treat the T2P resource as “water”. The T2P resource will “flow” into the bucket at a changing rate of T2PInflow and “flow” out from the bucket at a changing rate of T2POutflow. T2POutflow is mapped to transmit capability. A higher T2POutflow leads to a bigger packet size and higher data rate. The bucket also has a maximum level. So, the accumulated T2P resource cannot be increased unlimitedly.

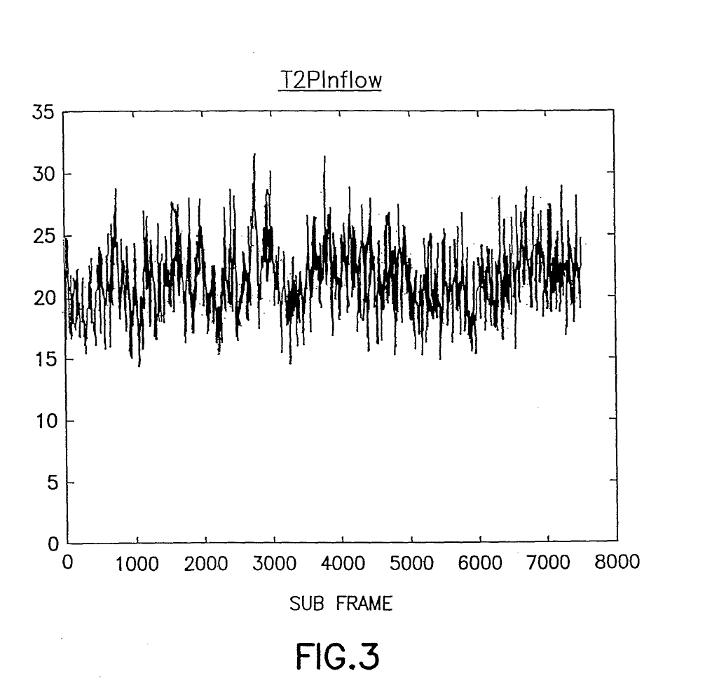

As defined in 3GPP2 C.S0024-A, Version 1.0, March 2004, “cdma2000 High Rate Packet Air Interface Specification”, ΔT2PInflow_{i,n} denotes an average T2P resource added to a bucket for Medium Access Control (MAC) flow i at a sub-frame n. However, ΔT2PInflow_{i,n} does not directly add to a bucket for MAC flow i at a sub-frame n. Instead, ΔT2PInflow_{i,n} will be used to adjust T2PInflow first, and the adjusted T2PInflow will then be added to the bucket. The T2PInflow is always positive and in units of raw value. A typical value of T2PInflow and its moving trend is shown in FIG. 3.

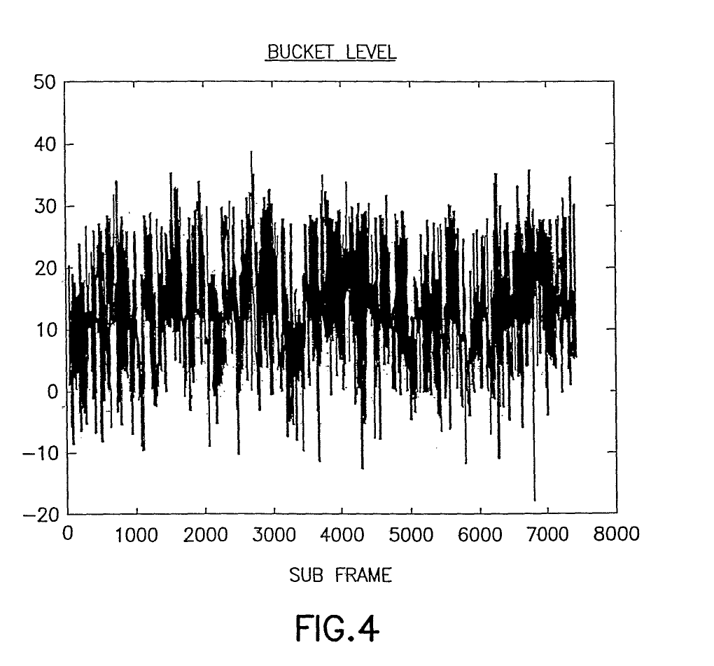

If in some sub-frame there is data to transmit and the bucket level is at least large enough to accommodate a smallest packet, then the MAC algorithm (e.g., as part of the RTCMAC 16 shown in FIG. 2) will choose a packet size to transmit, and the chosen packet size will require less T2P resource then the T2P resource indicated by the current bucket level. The T2P resource needed for this packet will decide T2POutflow for all transmissions in the following Hybrid Automatic Request (HARQ) process (e.g., performed by the RTCMAC 16 below or an element coupled to the RTCMAC 16). The bucket level will be reduced using T2POutflow as well. It is noted that the requirement of the bucket level being at least large enough to accommodate a smallest packet is true for a first transmission in accordance with a HARQ process. Starting from a second transmission, the packet has to be transmitted even though the bucket level might be negative. For instance, FIG. 4 shows a graph of exemplary bucket level (e.g., BucketLevel) over a number of sub-frames. One can see in FIG. 4 that the BucketLevel could be negative. As described above, one reason for a negative BucketLevel is because the HARQ process use additional T2POutflow from the bucket for transmissions beyond the first transmission. The T2POutflow of, e.g., the second burst might therefore be less than the instantaneous T2PInflow, which will cause the bucket level to be negative.

For the transmission power of the AT, the power will be decided using pilot power and T2P resources. It is possible to envision the transmission power of the AT using the following equation: Tx=TxPilot (1+T2P), where Tx is transmission power of the AT, TxPilot is an indication of the pilot power, and T2P in this equation is the T2P required for the packet being transmitted.

Another quantity useful when discussing T2P resources is QRAB. As defined in 3GPP2 C.S0024-A, Version 1.0, QRAB_{i,n} is the effective quick Reverse Activity Bit (RAB) value for MAC flow i at sub-frame n. When QRAB is a positive one, it means the network (e.g., a sector) is busy (e.g., loaded) in the short term (e.g., actually for the last four sub-frames, referenced from a current sub-frame, according to the default filter configuration for QRAB). So, the ΔT2PInflow will be negative and this will lead to a smaller T2PInflow. When QRAB is a negative one, this indicates that the network (e.g., sector) is hot busy (e.g., unloaded) in the short term. The ΔT2PInflow will be positive and this will lead to a larger T2PInflow.

The previous description outlines some concepts related to the disclosed invention. The non-limiting embodiments of this invention relate to the reverse link (RL) medium access control (MAC) layer in wireless communication systems, such as the RL traffic channel of Nx EV-DO (Multi-Carrier Evolution for Data Optimization).

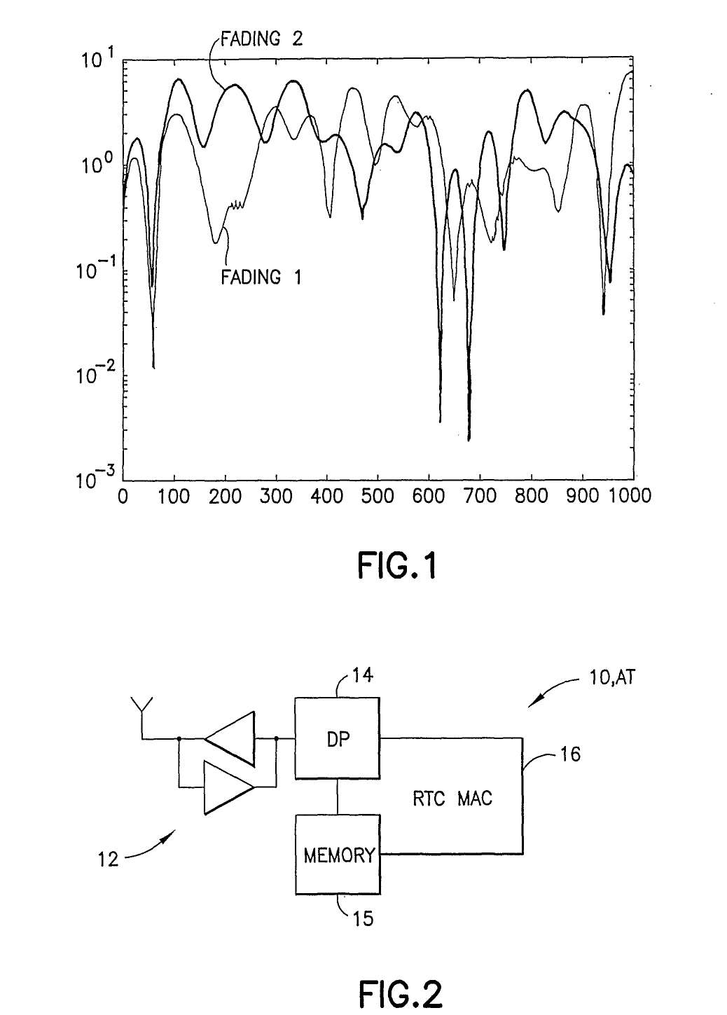

The inventors have realized that the RL MAC in the 1x EV-DO system will not operate very efficiently in Nx EV-DO, due at least to imbalances in Nx EV-DO, such as ROT imbalances and RL pilot power differences among different carriers used by one AT. ROT imbalances among different carriers can be caused by, for example, different numbers of active ATs and different traffic volumes in different carriers. For example, instantaneous ROT in f1 and f2 of AN1 are 4 dB and 6 dB, respectively. From a throughput and ROT point-of-view, a preference of higher data rates in lower ROT carrier(s) aids the system performance. In Nx EV-DO, RL pilot powers in different carriers will be different. The differences can be caused by ROT imbalances, different fading gain and different signal-to-interference (SIR) targets of the outer loop power control in different carriers. Fading in different carriers can be quite different, although the fading of carriers in the multi-carrier system is correlated. Transmission over carrier(s) with high fading gain helps to increase capacity. FIG. 1 shows correlated fading in two carriers with a correlation coefficient of 0.5. However, data shows that fading gains in two carriers are much different even when the correlation coefficient between their fading is 0.5. For example, pilot powers in f1 and f2 are 1 dbm and 5 dbm, respectively. A preference of higher data rates in low RL pilot power carrier(s) helps increase the system performance.

Furthermore, to achieve as much trunk efficiency as possible, information from other carriers is helpful to RL MAC in a carrier.

The non-limiting embodiments of this invention provide reverse link medium access control (RL-MAC) in multi-carrier CDMA systems. The non-limiting embodiments of this invention control T2P resources of an AT in a carrier according to, e.g., a Reverse Activity Bit (RAB) and the reverse link pilot power in all carriers. The use of the non-limiting embodiments of this invention provides that more data is transmitted over reverse link carrier(s) with smaller reverse pilot power and unloaded reverse link carrier(s).

If some carriers are unloaded and some carriers are loaded, ΔT2PInflow in unloaded carriers should be larger than that in 1x EV-DO, and ΔT2PInflow in loaded carriers should be smaller than that in 1x EV-DO.

If the carrier, c₁, is unloaded in the reverse link and other carriers are loaded in the reverse link, ΔT2PInflow in c₁ should be large to balance the load in multiple carriers.

If the carrier, c₁, is loaded in the reverse link and other carriers are unloaded in the reverse link, ΔT2PInflow in c₁ should be small to balance the load in multiple carriers.

If all the active carriers are loaded in reverse link, ΔT2PInflow should be the same as in 1x EV-DO.

If all the active carriers are unloaded in reverse link, ΔT2PInflow should be the same as 1x EV-DO.

Furthermore, reverse link pilot power in a carrier is compared with the average reverse link pilot power in all active reverse carriers. If the reverse link pilot power in a carrier is smaller than average, the carrier is economical so that its ΔT2PInflow can be larger. Otherwise, the carrier is uneconomic so that its ΔT2PInflow can be smaller. For instance, using the equation Tx=TxPilot (1+T2P), it can be seen that for the same transmission power (Tx), when the TxPilot (an indication of the pilot power) is smaller, the T2P can be increased relative to a higher TxPilot. Therefore, carriers with smaller TxPilot are more economical in the sense that more T2P can be used for the same Tx relative to a carrier having a higher TxPilot.

The gain results from the fact that more data are transmitted over more economical carriers. An unloaded carrier is more economical than a loaded carrier, and the carrier with a smaller reverse link pilot power is more economical. The non-limiting embodiments of this invention provide for balancing the reverse link load among the carriers, and increase system capacity and decrease the total transmit power of the access terminal.

The use of the non-limiting embodiments of this invention is important and unique for multi-carriers as the MAC does not handle ROT imbalance among carriers, and conventional ATs cannot dynamically select economical carriers to transmit in the reverse link. Consequently, aspects of the disclosed invention allow the AT to adjust dynamically T2P resource allocation based on loading (e.g., loaded or unloaded) of a carrier within a set of carriers and based on pilot powers for carriers within the set of carriers.

FIG. 2 shows an AT 10 that operates in accordance with non-limiting embodiments of this invention. The AT 10 includes a wireless transceiver 12, a data processor (DP) 14 and a memory 15. Execution of a computer program stored in the memory 15 by the DP 14 results in operation of a reverse traffic channel medium access control (RTCMAC) function 16 in accordance with the teachings of this invention.

In general, the various embodiments of the AT 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Before proceeding to some additional exemplary embodiments, it is helpful at this point to review some information known from 3GPP2 C.S0024-A, Version 1.0, March 2004, “cdma2000 High Rate Packet Air Interface Specification”. Although the following definitions can be found in 3GPP2 C.S0024-A, Version 1.0, these definitions are repeated here for ease of reference: QRAB_{i,n} is the effective quick Reverse Activity Bit (RAB) value for MAC flow i at sub-frame n; TT2PHold_{i,n} indicates the number of sub-frames following sub-frame n for which the T2P resource allocation, received via the Grant message, shall be maintained by the access terminal for MAC flow i; T2PDnᵢ( ) is a two-dimensional piecewise linear function for computing decrease in T2PInflow for MAC flow i based on current T2PInflow and current FRAB (an effective filtered RAB value reflecting the long term average loading, e.g. the most recent 128 sub-frames); T2PUpᵢ( ) is a two-dimensional piecewise linear function for computing increase in T2PInflow for MAC flow i based on current T2PInflow and current FRAB; PilotStrength( ) is a function that provides a scale factor for scaling T2PInflow_{i,n} based on the pilot strength of the forward link serving sector; PilotStrength_{n,s} is a filtered PilotStrength of sector s sampled at the start of sub-frame n; BucketLevel_{i,n} is bucket level (or accumulated T2P resource) at sub-frame n for MAC flow i; and BucketLevelSat_{i,n} is saturation level for BucketLevel_{i,n}. With regard to PilotStrength, the 3GPP2 C.S0024-A, Version 1.0 states the following: “The access terminal shall set this field to └−2×10×log₁₀ PS┘, where PS is the strength of the pilot in the above field, measured as specified in 9.7.6.1.2.3. If this value is less than 0, the access terminal shall set this field to ‘000000’. If this value is greater than ‘111111’, the access terminal shall set this field to ‘111111’.”

The non-limiting and exemplary embodiments of this invention may be implemented by the RTCMAC function 16 as follows.

The modifications to the current specification text (3GPP2 C.S0024-A, Version 1.0, March 2004, “cdma2000 High Rate Packet Air Interface Specification”) are shown below along with material from the current specification. One difference between the current specification text and the modifications is how some of the terms are based not only on MAC flow (e.g., MAC flow i) and sub-frame (e.g., sub-frame n), but also based on carrier. For instance, as described in more detail below, the entity “j” in the following modifications is used to indicate a particular carrier of a number of carriers assigned to the access terminal. As more particular examples, in 3GPP2 C.S0024-A, Version 1.0 TT2PHold depended only on i (i.e., MAC flow i) and n−1 (i.e., sub-frame n−1) and QRAB depended only on i and n (i.e., sub-frame n), but below TT2PHold depends on i, n−1, and j (i.e., carrier j), and QRAB depends on i, n, and j. Other examples are evident below.

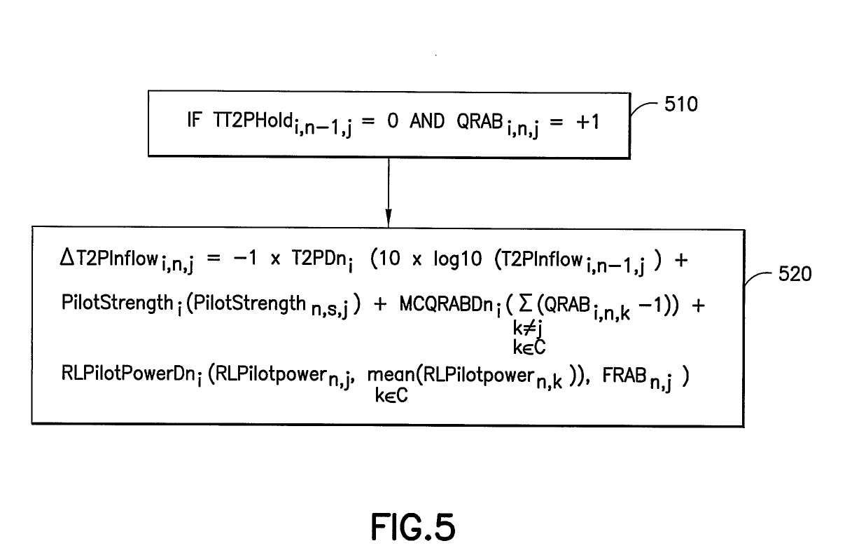

Turning to FIG. 5, a flowchart is shown of an exemplary method for determining that a carrier is loaded and for adjusting transmission resource for the carrier based on the determination. In step 510, it is determined if TT2PHold_{i,n-1},j==0 and QRAB_{i,n,j}==+1. If so, the access terminal shall compute ΔT2PInflow_{i,n,j} using the following equation (step 520):

$$Δ T 2 {PInflow}_{i , n , j} = - 1 \times T 2 {PDn}_{i} ( 10 \times log 10 ( T 2 {PInflow}_{i , n - 1 , j} ) + {PilotStrength}_{i} ( {PilotStrength}_{n , s , j} ) + {MCQRABDn}_{i} ( {\sum }_{{k \neq j}_{k ∈ C}} ( {QRAB}_{i , n , k} - 1 ) ) + {RLPilotPowerDn}_{i} ( {RLPilotpower}_{n , j} , {mean}_{k ∈ C} ( {RLPilotpower}_{n , k} ) ) , {FRAB}_{n , j} )$$

where s is the forward link serving sector for the access terminal, j is for carrier j for the access terminal, C is the active reverse link carrier set for the access terminal,
where MCQRABDnᵢ( ) is a one-dimensional piecewise linear function for computing decrease in T2PInflow for MAC flow i based on the sum of current QRAB minus 1 of all the active reverse link carriers except the j'th carrier, and
where RLPilotPowerDnᵢ( ) is a two-dimensional piecewise linear function for computing decrease in T2PInflow for MAC flow i based on the current filtered reverse link pilot power of the j'th carrier and the average value of current filtered reverse link pilot powers in all the active reverse link carriers.

It is noted that QRAB_{i,n,j}==+1 means that the carrier j for the sub-frame n and the MAC flow i is loaded. As compared with the current specification text (3GPP2 C.S0024-A, Version 1.0, March 2004), j, C, MCQRABDnᵢ( ) and RLPilotPowerDni( ) are new, and TT2PHOld_{i,n}−1j, ΔT2PInflow_{i,n,j}, QRAB_{i,n,j}, and PilotStrength_{n,s,j} have been modified by carrier, j. Furthermore, the subtraction of one from QRAB (i.e.,

$${\sum }_{{k \neq j}_{k ∈ C}} ( {QRAB}_{i , n , k} - 1 ) )$$

will change the x value in MCQRABDnᵢ( ) and in the default parameter table (see below). A benefit to subtracting one from QRAB is a decrease in the actual bits needed to represent the x axis of the function as compared to not subtracting one. However, the subtraction of one may not be necessary if more bits can be devoted to the x axis of the function. In more general terms, the sum of QRAB may include subtraction of a constant, where the constant could be one, zero, or some other value including negative numbers.
MCQRABDnᵢ( ) has the following non-limiting embodiment:
MCQRABDnᵢ(x)=−max(Δ_{Dn}_{_{—}}_{load}×x/2, Δ_{Dn}_{_{—}}_{load}_{_{—}}ₗᵢₘ) where Δ_{Dn}_{_{—}}_{load} is a parameter for adjustment step due to load imbalances among multiple carriers when the carrier is loaded, and Δ_{Dn}_{_{—}}_{load}_{_{—}}ₗᵢₘ is a parameter for the adjustment limit due to load imbalances among multiple carriers when the carrier is loaded. It is noted that MCQRABDnᵢ(x), in an exemplary embodiment, only needs to be designed as a monotonic-decreasing function given x's range is between some negative value and zero and the output of MCQRABDnᵢ(x) is between a positive value and zero because T2PDnᵢ(x, y) is designed to be a monotonic-increasing function of x. For instance, when carriers other than the j'th carrier are lightly loaded,

$${\sum }_{{k \neq j}_{k ∈ C}} ( {QRAB}_{i , n , k} - 1 )$$

will be a larger negative value relative to when the carriers other than the j'th carrier are loaded to a higher extent. The MCQRABDnᵢ(x) will be a higher positive value relative to when the carriers other than the j'th carrier are loaded to a higher extent. Considering only the contribution by MCQRABDnᵢ(x) to T2PDnᵢ(x, y), then T2PDnᵢ(x, y) will be a higher value, leading to a value that is more negative for ΔT2PInflow_{i,n,j} (i.e., leading to a larger decrease in ΔT2PInflow for the j'th carrier). Thus, MCQRABDnᵢ(x) in combination with T2PDnᵢ(x, y) leads to a larger decrease in ΔT2PInflow_{i,n,j} when the carrier loading for all the carriers other than the j'th carrier is lower, indicating that more T2P transmission resource is allocated to carriers with lower loading.

RLPilotPowerDnᵢ( ) has the following non-limiting embodiment:

RLPilotPowerDnᵢ(x,y)=+max(Δ_{Dn}_{_{—}}ₚᵢₗₒₜ×(10×log 10(x)−10×log 10(y)),Δ_{Dn}_{_{—}}ₚᵢₗₒₜ_{_{—}}ₗᵢₘ)

where RLPilotpower_{n,j} is the filtered reverse link pilot power (with filter time constant RLPPFilterTC) in carrier j in sub-frame n, Δ_{Dn}_{_{—}}ₚᵢₗₒₜ is a parameter for adjustment step due to different fading gains in multiple carriers when the carrier is loaded and Δ_{Dn}_{_{—}}ₚᵢₗₒₜ_{_{—}}ₗᵢₘ is a parameter for the adjustment limit due to different fading gains in multiple carriers when the carrier is loaded. It is noted that RLPilotPowerDnᵢ(x, y), in an exemplary embodiment, only needs to be designed as a monotonic-increasing function of 10*log 10(x/y) and its output should be zero when 10*log 10(x/y) is zero. For instance, when RLPilotpower_{n,j} is larger relative to

$${mean}_{k ∈ C} ( {RLPilotpower}_{n , k} ) ,$$

then RLPilotPowerDnᵢ will be a higher value, which will lead to a higher value (considering only the contribution by RLPilotPowerDnᵢ) of T2PDnᵢ, which in turns leads to a larger decrease in ΔT2PInflow_{i,n,j}. Therefore, more T2P transmission resource is transferred to carriers having lower pilot powers.

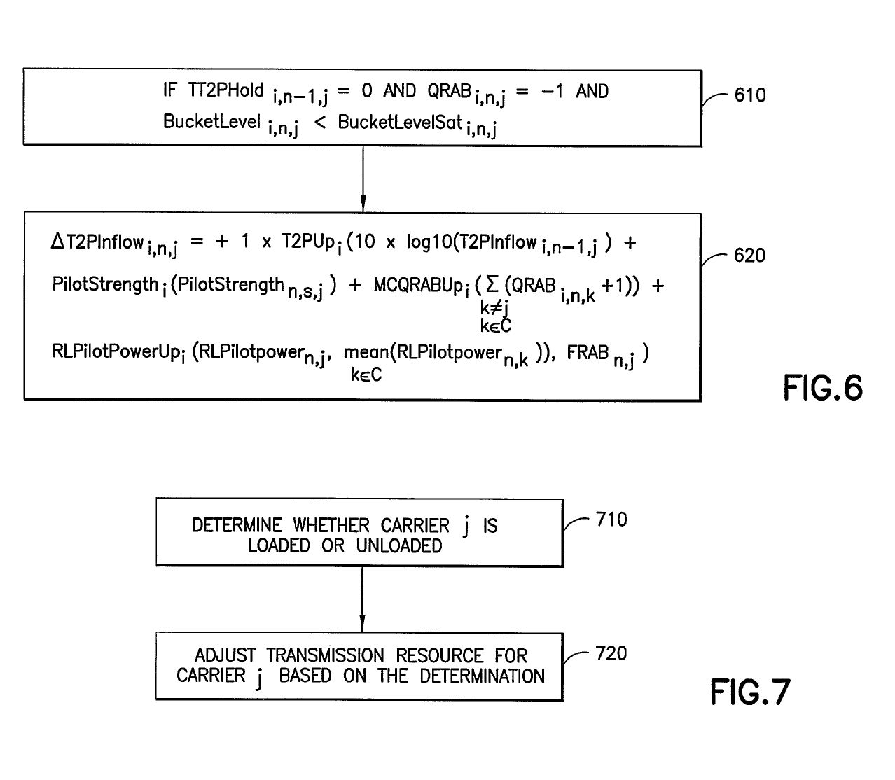

Referring now to FIG. 6, a flowchart is shown of an exemplary method for determining that a carrier is unloaded and for adjusting transmission resource for the carrier based on the determination. In step 610 it is determined if TT2PHold_{i,n-1,j}=0 and QRAB_{i,n,j}=−1 and BucketLevel_{i,n,j}<BucketLevelSat_{i,n,j}. If so, then the access terminal shall compute ΔT2PInflow_{i,n,j} using the following equation (step 620):

$$Δ T 2 {PInflow}_{i , n , j} = - 1 \times T 2 {PUp}_{i} ( 10 \times {log }_{10} ( T 2 {PInflow}_{i , n - 1 , j} ) + {PilotStrength}_{i} ( {PilotStrength}_{n , s , j} ) + {MCQRABUp}_{i} ( {\sum }_{{k \neq j}_{k ∈ C}} ( {QRAB}_{i , n , k} + 1 ) ) + {RLPilotPowerUp}_{i} ( {RLPilotpower}_{n , j} , {mean}_{k ∈ C} ( {RLPilotpower}_{n , k} ) ) , {FRAB}_{n , j} )$$

where s is the forward link serving sector for the access terminal, j is for the j^{th} carrier for the access terminal, C is the active reverse link carrier set for the access terminal,
where MCQRABUpi( ) is a one-dimensional piecewise linear function for computing increase in T2PInflow for MAC flow i based on the sum of current QRAB plus 1 of all active reverse link carriers except the j'th carrier, and
where RLPilotPowerUpᵢ( ) is a two-dimensional piecewise linear function for computing increase in T2PInflow for MAC flow i based on the current filtered reverse link pilot power of the j'th carrier and the average value of current filtered reverse link pilot powers of all the active reverse link carriers.
It is noted that QRABi,n,j==−1 means that the carrier j for the sub-frame n and the MAC flow i is unloaded. As compared with the current specification text (3GPP2 C.S0024-A, Version 1.0, March 2004), j, C, MCQRABDpi( ) and RLPilotPowerUpi( ) are new, and TT2PHold_{i,n-1,j}, QRAB_{i,n,j}, ΔT2PInflow_{i,n,j}, PilotStrength_{n,s,j}, BucketLevel_{i,n,j}, BucketLevelSat_{i,n,j}, and FRAB_{n,j} have been modified by carrier, j. As with the subtraction of one from QRAB, the addition of one to QRAB has a benefit of fewer bits to represent the x axis of the MCQRABUpᵢ( ) function. If more bits can be devoted, however, to the x axis, then the addition of one to QRAB need not be performed. In more general terms, the sum of QRAB may include an addition of a constant, where the constant could be one, zero, or some other value including negative numbers.
MCQRABUpᵢ( ) has the following non-limiting embodiment:

MCQRABUpᵢ(x)=−min(Δ_{Up}_{_{—}}_{load}×x/2,Δ_{Up}_{_{—}}_{load}_{_{—}}ₗᵢₘ)
where Δ_{Up}_{_{—}}_{load} is a parameter for adjustment step due to load imbalances among multiple carriers when the carrier is unloaded and Δ_{Up}_{_{—}}_{load}_{_{—}}ₗᵢₘ is a parameter for the adjustment limit due to load imbalances among multiple carriers when the carrier is unloaded. It is noted that MCQRABUpᵢ(x), in an exemplary embodiment, only needs to be designed as a monotonic-decreasing function given x's range is between zero and some positive value and the output if MCQRABUpᵢ(x) is between zero and some negative value because T2PUpᵢ(x, y) is designed to be a monotonic-decreasing function of x. For instance, when carriers other than the j'th carrier are highly loaded,

$${\sum }_{{k \neq j}_{k ∈ C}} ( {QRAB}_{i , n , k} + 1 )$$

will be a larger positive value relative to when the carriers other than the j'th carrier are loaded to a lower extent. The MCQRABUpᵢ(x) will be a largest negative value relative to when the carriers other than the j'th carrier are loaded to a lower extent. Considering only the contribution by MCQRABUpᵢ(x) to T2PUpᵢ(x, y), then T2PUpⁱ (x, y) will be a higher value, leading to a value that is higher (i.e., more positive) for ΔT2PInflow_{i,n,j} (i.e., leading to a larger increase in ΔT2PInflow for the j'th carrier). Thus, MCQRABUpi(x) in combination with T2PUpᵢ(x, y) leads to a larger increase in ΔT2PInflow_{i,n,j} when the carrier loading for all the carriers other than the j'th carrier is higher, indicating that more T2P transmission resource is allocated to carriers with lower loading.

RLPilotPowerUpᵢ( ) has the following non-limited embodiment:

RLPilotPowerUpᵢ(x,y)=+max(Δ_{Up}_{_{—}}ₚᵢₗₒₜ×(10×log 10(x)−10×log 10(y)),Δ_{Up}_{_{—}}ₚᵢₗₒₜ_{_{—}}ₗᵢₘ)
where RLPilotpowe_{n,j} is the filtered reverse link pilot power (with filter time constant RLPPFilterTC) in carrier j in sub-frame n, Δ_{Up}_{_{—}}ₚᵢₗₒₜ is a parameter for adjustment step due to different fading gains in multiple carriers when the carrier is unloaded and Δ_{Up}_{_{—}}ₚᵢₗₒₜ_{_{—}}ₗᵢₘ is a parameter for the adjustment limit due to different fading gains in multiple carriers when the carrier is unloaded. It is noted that RLPilotPowerUpᵢ(x, y), in an exemplary embodiment, only needs to be designed as a monotonic-increasing function of 10*log 10(x/y) and its output should be zero when 10*log 10(x/y) is zero. For instance, when RLPilotpower_{n,j} is larger relative to

$${mean}_{k ∈ C} ( {RLPilotpower}_{n , k} ) ,$$

then RLPilotPowerUpᵢ will be a higher value, which will lead to a lower value (considering only the contribution by RLPilotPowerUpᵢ) of T2PUpᵢ, which in turns leads to a smaller increase in ΔT2PInflow_{i,n,j}. Therefore, more T2P transmission resource is transferred to carriers having lower pilot powers.

It is worth mentioning that MCQRABDni(x) is a monotonic-decreasing function because of the definition of x. Given another definition of the range of x, for example using a negative representation of the current definition for the range of x, MCQRABDnᵢ(x) could be defined as monotonic-increasing function as well. The other three functions, RLPilotPowerDnᵢ, MCQRABUpᵢ, and RLPilotPowerUpᵢ may also be similarly modified. Furthermore, any of the monotonic-increasing or monotonic-decreasing functions described above can be further generalized to linear operators. For instance, given x belonging to a set, C, in which xᵢ represents relatively unloaded carriers and xⱼ represents relatively loaded carriers, the output from a linear operator such as, e.g., MCQRABDnᵢ(x), will be a larger positive number for xᵢ than for xⱼ, with the special case that the output should be zero if all carriers are loaded. As another example, given x belonging to a set, C, in which xᵢ represents carriers with higher pilot power and xⱼ represents carriers with lower pilot powers, the output from a linear operator such as, e.g., RLPilotPowerDnᵢ(x,y), will be a smaller positive number for xᵢ than for xⱼ, with the special case that the output should be zero if all carriers have the same pilot powers.

In accordance with the examples given above, one can appreciate that an aspect of the invention relates to determining loading for a carrier and adjusting transmission resource for the carrier based on the determination. In FIG. 7 a method is shown regarding this aspect. In step 710, it is determined whether information corresponding to one of a number of carriers indicates that the one carrier is loaded or unloaded. As described above, the carriers are used for transmission of a MAC flow by the AT over a reverse link. In step 720, responsive to the determining, transmission resource allocation is adjusted, the transmission resource corresponding to the MAC flow for the one carrier. The adjustment is based at least in part on information corresponding to carrier loading for each of the carriers and on information corresponding to reverse link pilot power for each of the carriers, as has been described above (e.g., in relation to FIGS. 5 and 6).

The following are also new: Δ_{Dn}_{_{—}}_{load}, Δ_{Up}_{_{—}}_{load}, Δ_{Dn}_{_{—}}_{load}_{_{—}}ₗᵢₘ, Δ_{Up}_{_{—}}_{load}_{_{—}}ₗᵢₘ, Δ_{Dn}_{_{—}}ₚᵢₗₒₜ, Δ_{Up}_{_{—}}ₚᵢₗₒₜ, Δ_{Dn}_{_{—}}ₚᵢₗₒₜ_{_{—}}ₗᵢₘ, Δ_{Up}_{_{—}}ₚᵢₗₒₜ_{_{—}}ₗᵢₘ and RLPPFilterTC. These are added to simple attributes as shown below.

| Attribute | | | | |
|---|---|---|---|---|
| ID | Attribute | Values | Meaning | |
| 0xfb00 | Δ_{Dn}_{_{—}}load | 0x00 | 0.125 | dB |
| | | 0x01 | 0.25 | dB |
| | | 0x02 | 0.5 | dB |
| | | All other | Reserved | |
| | | values | | |
| 0xfb01 | Δ_{Dn}_{_{—}}load_lim | 0x00 | 0 | dB |
| | | 0x01 | −0.5 | dB |
| | | 0x02 | −1 | dB |
| | | 0x03 | −1.5 | dB |
| | | 0x04 | −2 | dB |
| | | 0x05 | −2.5 | dB |
| | | 0x06 | −3 | dB |
| | | 0x07 | −3.5 | dB |
| | | 0x08 | −4 | dB |
| | | All other | Reserved | |
| | | values | | |
| 0xfb02 | Δ_{Up}_{_{—}}load | 0x00 | 0.125 | dB |
| | | 0x01 | 0.25 | dB |
| | | 0x02 | 0.5 | dB |
| | | All other | Reserved | |
| | | values | | |
| 0xfb03 | Δ_{Up}_{_{—}}load_lim | 0x00 | 0 | dB |
| | | 0x01 | 0.5 | dB |
| | | 0x02 | 1 | dB |
| | | 0x03 | 1.5 | dB |
| | | 0x04 | 2 | dB |
| | | 0x05 | 2.5 | dB |
| | | 0x06 | 3 | dB |
| | | 0x07 | 3.5 | dB |
| | | 0x08 | 4 | dB |
| | | All other | Reserved | |
| | | values | | |
| 0xfb04 | Δ_{Dn}_{_{—}}pilot | 0x00 | 0.125 | dB |
| | | 0x01 | 0.25 | dB |
| | | 0x02 | 0.5 | dB |
| | | All other | Reserved | |
| | | values | | |
| 0xfb05 | Δ_{Dn}_{_{—}}pilot_lim | 0x00 | 0 | dB |
| | | 0x01 | −0.5 | dB |
| | | 0x02 | −1 | dB |
| | | 0x03 | −1.5 | dB |
| | | 0x04 | −2 | dB |
| | | 0x05 | −2.5 | dB |
| | | 0x06 | −3 | dB |
| | | 0x07 | −3.5 | dB |
| | | 0x08 | −4 | dB |
| | | All other | Reserved | |
| | | values | | |
| 0xfb06 | Δ_{Up}_{_{—}}pilot | 0x00 | 0.125 | dB |
| | | 0x01 | 0.25 | dB |
| | | 0x02 | 0.5 | dB |
| | | All other | Reserved | |
| | | values | | |
| 0xfb07 | Δ_{Up}_{_{—}}pilot_lim | 0x00 | 0 | dB |
| | | 0x01 | −0.5 | dB |
| | | 0x02 | −1 | dB |
| | | 0x03 | −1.5 | dB |
| | | 0x04 | −2 | dB |
| | | 0x05 | −2.5 | dB |
| | | 0x06 | −3 | dB |
| | | 0x07 | −3.5 | dB |
| | | 0x08 | −4 | dB |

| | | | |
|---|---|---|---|
| | | All other | Reserved |
| | | values | |
| 0xfb08 | RLPPFilterTC | 0x00 | IIR filter time constant |
| | | | used by the access terminal |
| | | | for computing the reverse |
| | | | link pilot power is 4 slots. |
| | | 0x01 | IIR filter time constant |
| | | | used by the access terminal |
| | | | for computing the reverse |
| | | | link pilot power is 8 slots. |
| | | All other | Reserved |
| | | values | |

Based on the foregoing description, it can be appreciated that the non-limiting embodiments of this invention provide a method, apparatus and a computer program product to be implemented in an AT 10 as shown in FIG. 2 to combine RAB from all active carriers to provide even more aggressive T2P resource allocation to a comparatively unloaded carrier (as compared to all RL carriers used by the AT), and to decrease the T2P resource allocation relative to the comparatively loaded carrier. Furthermore, the relative fairness among all the ATs to access the network is not infringed because the method increases the data rate of all individual ATs, most likely in a proportional way according to individual AT's location to the serving sector.

The disclosed invention may also be implemented as a computer program product embodied on a computer readable medium and including program instructions readable by a data processor to perform operations described herein. The memory 15 may be of any type suitable to the local technical environment and may be implemented using any suitable data storage technology, such as semiconductor based memory devices, magnetic memory devices and systems, optical memory devices and systems, fixed memory and removable memory. The data processor 14 may be of any type suitable to the local technical environment, and may include one or more of general purpose computers, special purpose computers, microprocessors, digital signal processors (DSPs) and processors based on multi-core processor architecture, as non limiting examples.

In general, the various embodiments may be implemented in hardware or special purpose circuits, software, logic, or any combination thereof. For example, some aspects may be implemented in hardware, while other aspects may be implemented in software (e.g., firmware) which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings. However, all such modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method performed in an access terminal, comprising:
determining whether information corresponding to one of a plurality of carriers indicates the one carrier is loaded or unloaded, wherein the plurality of carriers are used for transmission of a medium access control (MAC) flow by the access terminal over a reverse link; and
responsive to the determining, adjusting transmission resource allocation corresponding to the MAC flow for the one carrier, the adjusting based at least in part on information corresponding to carrier loading for each of the plurality of carriers and on information corresponding to reverse link pilot power for each of the plurality of carriers.

2. A method as in claim 1, wherein each of the plurality of carriers comprises an active carrier in a reverse link carrier set assigned to the access terminal.

3. A method as in claim 1, wherein the transmission resource allocation comprises an accumulated traffic channel power to pilot power (T2P) resource for a bucket corresponding to the one carrier.

4. A method as in claim 3, wherein adjusting transmission resource allocation further comprises:
computing an average T2P resource;
adding the average T2P resource to a rate of transmission resource inflow corresponding to the bucket; and
adding to the bucket a result of adding the computed average T2P resource to the rate of transmission resource inflow.

5. A method as in claim 4, further comprising:
transmitting at least a portion of the MAC flow on the one carrier based on the adjusted transmission resource allocation; and
removing from the bucket transmission resource corresponding to the portion of the MAC flow.

6. A method as in claim 1, wherein:
determining further comprises determining whether the information of carrier loading for the one carrier indicates the one carrier is loaded for at least one sub-frame relative to a current sub-frame for the MAC flow; and
adjusting further comprises, in response to the information of carrier loading for the one carrier indicating the one carrier is loaded, calculating ΔT2PInflow, an average transmission resource to be added to the bucket for the MAC flow at the current sub-frame, wherein calculating ΔT2PInflow is performed so that a decrease occurs for the transmission resource for the bucket at the current sub-frame.

7. A method as in claim 6, wherein determining whether the information of carrier loading for the one carrier indicates the one carrier is loaded for at least one sub-frame relative to a current sub-frame for the MAC flow further comprises determining that the information includes an effective quick Reverse Activity Bit (RAB) value (QRAB) being equal to one, the QRAB corresponding to the MAC flow, the current sub-frame, and the one carrier.

8. A method as in claim 7, wherein calculating is further performed in response to a zero value for a value indicating a number of sub-frames following a sub-frame n−1 previous to the current sub-frame n for which transmission resource allocation shall be maintained by the access terminal for the MAC flow.

9. A method as in claim 7, wherein calculating further comprises:
computing a result of a linear operator, the linear operator for determining a decrease in ΔT2Pinflow based on a sum of current QRAB minus a constant for each of the plurality of carriers except the one carrier;
computing the ΔT2PInflow based at least on the result of the linear operator; and
adding the computed ΔT2PInflow to a current T2PInflow corresponding to the one carrier, the T2PInflow being a rate of transmission resource inflow into the bucket.

10. A method as in claim 9, wherein the linear operator comprises a monotonic decreasing function, and wherein computing the ΔT2PInflow based at least on the result of the linear operator further comprises computing the ΔT2PInflow by multiplying a negative one with a result of a monotonic increasing function, the monotonic increasing function using at least a result of the monotonic decreasing function.

11. A method as in claim 9, wherein the linear operator comprises a one-dimensional piecewise linear function −max(Δ_{Dn}_{_{—}}_{load}×x/2,Δ_{Dn}_{_{—}}_{load}_{_{—}}ₗᵢₘ), where max( ) selects a maximum value between two values, Δ_{Dn}_{_{—}}_{load} is a parameter for adjustment step due to load imbalances among multiple carriers when a carrier is loaded, Δ_{Dn}_{_{—}}_{load}_{_{—}}ₗᵢₘ is a parameter for the adjustment limit due to load imbalances among multiple carriers when a carrier is loaded, and x is
$${\sum }_{{k \neq j}_{k ∈ C}} ( {QRAB}_{i , n , k} - 1 ) ,$$
where the MAC flow is MAC flow i, the current sub-frame is sub-frame n, and the one carrier is the carrier j, and C is an active reverse link carrier set for the access terminal.

12. A method as in claim 7, wherein calculating further comprises:
computing a result of a linear operator, the linear operator for determining a decrease in ΔT2PInflow based on a current filtered reverse link pilot power of the one carrier and an average value of current filtered reverse link pilot powers in all the other plurality of carriers;
computing the ΔT2PInflow based at least on the result of the linear operator; and
adding the computed ΔT2PInflow to a current T2PInflow corresponding to the bucket, the T2PInflow being a rate of transmission resource inflow into the bucket.

13. A method as in claim 12, wherein the linear operator comprises a first monotonic increasing function, and wherein computing the ΔT2PInflow based at least on the result of the linear operator further comprises computing the ΔT2PInflow by multiplying a negative one with a result of a second monotonic increasing function, the second monotonic increasing function using at least a result of the first monotonic increasing function.

14. A method as in claim 12, wherein the linear operator comprises a two-dimensional piecewise linear function +max(Δ_{Dn}_{_{—}}ₚᵢₗₒₜ×(10×log 10(x)−10×log 10(y)),Δ_{Dn}_{_{—}}ₚᵢₗₒₜ_{_{—}}ₗᵢₘ), where max( ) selects a maximum value between two values, Δ_{Dn}_{_{—}}ₚᵢₗₒₜ is a parameter for adjustment step due to different fading gains in multiple carriers when a carrier is loaded, Δ_{Dn}_{_{—}}ₚᵢₗₒₜ_{_{—}}ₗᵢₘ is a parameter for the adjustment limit due to different fading gains in multiple carriers when a carrier is loaded, where x is RLPilotpower_{n,j}, which is a filtered reverse link pilot power with filter time constant RLPPFilterTC in the one carrier j at the current sub-frame n, and y is
$${mean}_{k ∈ C} ( {RLPilotpower}_{n , k} ) ,$$
where mean(·) determines a mean and C is an active reverse link carrier set for the access terminal.

15. A method as in claim 1, wherein:
determining further comprises determining whether the information of carrier loading for the one carrier indicates the one carrier is unloaded for at least one sub-frame relative to a current sub-frame for the MAC flow; and
adjusting further comprises in response to the information of carrier loading for the one carrier indicating the one carrier is unloaded, calculating ΔT2PInflow, an average transmission resource to be added to the bucket for the MAC flow at the current sub-frame, wherein calculating ΔT2PInflow is performed so that an increase occurs for the transmission resource for the bucket at the current sub-frame.

16. A method as in claim 15, wherein determining whether the information of carrier loading for the one carrier indicates the one carrier is unloaded for at least one sub-frame relative to a current sub-frame for the MAC flow further comprises determining that the information includes an effective quick Reverse Activity Bit (RAB) value (QRAB) being equal to negative one, the QRAB corresponding to the MAC flow, the current sub-frame, and the one carrier.

17. A method as in claim 16, wherein calculating is further performed in response to a zero value for a value indicating a number of sub-frames following a sub-frame n−1 previous to the current sub-frame n for which transmission resource allocation shall be maintained by the access terminal for the MAC flow.

18. A method as in claim 16, wherein calculating further comprises:
computing a result of a linear operator, the linear operator for determining an increase in ΔT2PInflow based on a sum of current QRAB plus a constant for each of the plurality of carriers except the one carrier;
computing the ΔT2PInflow based at least on the result of the linear operator; and
adding the computed ΔT2PInflow to a current T2PInflow corresponding to the one carrier, the T2PInflow being a rate of transmission resource inflow into the bucket.

19. A method as in claim 18, wherein the linear operator comprises a first monotonic decreasing function, and wherein computing the ΔT2PInflow based at least on the result of the linear operator further comprises computing the ΔT2PInflow based on at least a result of a second monotonic decreasing function, the second monotonic decreasing function using at least a result of the first monotonic decreasing function.

20. A method as in claim 18, wherein the linear operator comprises a one-dimensional piecewise linear function −min(Δ_{Up}_{_{—}}_{load}×x/2,Δ_{Up}_{_{—}}_{load}_{_{—}}ₗᵢₘ), where min( ) selects a minimum value between two values, Δ_{Up}_{_{—}}_{load} is a parameter for adjustment step due to load imbalances among multiple carriers when a carrier is unloaded, Δ_{Up}_{_{—}}_{load}_{_{—}}ₗᵢₘ is a parameter for the adjustment limit due to load imbalances among multiple carriers when a carrier is unloaded, and x is
$${\sum }_{{k \neq j}_{k ∈ C}} ( {QRAB}_{i , n , k} + 1 ) ,$$
where the MAC flow is MAC flow i, the current sub-frame is sub-frame n, and the one carrier is the carrier j, and C is an active reverse link carrier set for the access terminal.

21. A method as in claim 16, wherein calculating further comprises:
computing a result of a linear operator for determining an increase in ΔT2PhInflow based on a current filtered reverse link pilot power of the one carrier and an average value of current filtered reverse link pilot powers in all the other plurality of carriers;
computing the ΔT2PInflow based at least on the result of the linear operator; and
adding the computed ΔT2PInflow to a current T2PInflow corresponding to the bucket, the T2PInflow being a rate of transmission resource inflow into the bucket.

22. A method as in claim 21, wherein the linear operator comprises a monotonic increasing function, and wherein computing the ΔT2PInflow based at least on the result of the linear operator further comprises computing the ΔT2PInflow based on at least a result of a monotonic decreasing function, the monotonic decreasing function using at least a result of the monotonic increasing function.

23. A method as in claim 21, wherein the linear operator comprises a two-dimensional piecewise linear function +max(Δ_{Up}_{_{—}}ₚᵢₗₒₜ×(10×log 10(y)),Δ_{Up}_{_{—}}ₚᵢₗₒₜ _{_{—}}ₗᵢₘ), where max( ) selects a maximum value between two values, Δ_{Up}_{_{—}}ₚᵢₗₒₜ is a parameter for adjustment step due to different fading gains in multiple carriers when a carrier is unloaded, Δ_{Up}_{_{—}}ₚᵢₗₒₜ_{_{—}}ₗᵢₘ is a parameter for the adjustment limit due to different fading gains in multiple carriers when a carrier is unloaded, where x is RLPilotpower_{n,j}, which is a filtered reverse link pilot power with filter time constant RLPPFilterTC in the one carrier j at the current sub-frame n, and y is
$${mean}_{k ∈ C} ( {RLPilotpower}_{n , k} ) ,$$
where mean(·) determines a mean and C is an active reverse link carrier set for the access terminal.

24. An access terminal, comprising a function operable to determine whether information corresponding to one of a plurality of carriers indicates the one carrier is loaded or unloaded, wherein the plurality of carriers are used for transmission of a medium access control (MAC) flow by the access terminal over a reverse link, wherein the function is also operable to adjust, responsive to the determination, transmission resource allocation corresponding to the MAC flow for the one carrier, the adjustment based at least in part on information corresponding to carrier loading for each of the plurality of carriers and on information corresponding to reverse link pilot power for each of the plurality of carriers.

25. An access terminal as in claim 25, wherein the function is formed at least in part in an integrated circuit.

26. An access terminal as in claim 25, further comprising a data processor, and wherein the function comprises at least in part executable instructions suitable for execution on a data processor.

27. An access terminal as in claim 24, wherein the function is further operable when determining to determine whether the information of carrier loading for the one carrier indicates the one carrier is loaded for at least one sub-frame relative to a current sub-frame for the MAC flow, and, wherein the function is further operable when adjusting transmission resource allocation in response to the information of carrier loading for the one carrier indicating the one carrier is loaded, to calculate ΔT2PInflow, an average transmission resource to be added to the bucket for the MAC flow at the current sub-frame, wherein calculating ΔT2PInflow is performed so that a decrease occurs for the transmission resource for the bucket at the current sub-frame.

28. An access terminal as in claim 27, wherein the function is further operable when determining whether the information of carrier loading for the one carrier indicates the one carrier is loaded for at least one sub-frame relative to a current sub-frame for the MAC flow to determine that the information includes an effective quick Reverse Activity Bit (RAB) value (QRAB) being equal to one, the QRAB corresponding to the MAC flow, the current sub-frame, and the one carrier.

29. An access terminal as in claim 28, wherein the function is further operable when calculating to compute a result of a linear operator, the linear operator for determining a decrease in ΔT2PInflow based on a sum of current QRAB minus a constant for each of the plurality of carriers except the one carrier, to compute the ΔT2PInflow based at least on the result of the linear operator, and to add the computed ΔT2PInflow to a current T2PInflow corresponding to the one carrier, the T2PInflow being a rate of transmission resource inflow into the bucket.

30. An access terminal as in claim 28, wherein the function is further operable when calculating to compute a result of a linear operator, the linear operator for determining a decrease in ΔT2PInflow based on a current filtered reverse link pilot power of the one carrier and an average value of current filtered reverse link pilot powers in all the other plurality of carriers, to compute the ΔT2PInflow based at least on the result of the linear operator, and to add the computed ΔT2PInflow to a current T2PInflow corresponding to the bucket, the T2PInflow being a rate of transmission resource inflow into the bucket.

31. An access terminal as in claim 24, wherein the function is further operable when determining to determine whether the information of carrier loading for the one carrier indicates the one carrier is unloaded for at least one sub-frame relative to a current sub-frame for the MAC flow, and, wherein the function is further operable when adjusting, in response to the information of carrier loading for the one carrier indicating the one carrier is unloaded, transmission resource allocation to calculate ΔT2PInflow, an average transmission resource to be added to the bucket for the MAC flow at the current sub-frame, wherein calculating ΔT2PInflow is performed so that an increase occurs for the transmission resource for the bucket at the current sub-frame.

32. An access terminal as in claim 31, wherein the function is further operable when determining whether the information of carrier loading for the one carrier indicates the one carrier is unloaded for at least one sub-frame relative to a current sub-frame for the MAC flow to determine that the information includes an effective quick Reverse Activity Bit (RAB) value (QRAB) being equal to negative one, the QRAB corresponding to the MAC flow, the current sub-frame, and the one carrier.

33. Ali access terminal as in claim 32, wherein the function is further operable when calculating to compute a result of a linear operator, the linear operator for determining an increase in ΔT2PInflow based on a sum of current QRAB plus constant for each of the plurality of carriers except the one carrier, to compute the ΔT2PInflow based at least on the result of the linear operator, and to add the computed ΔT2PInflow to a current T2PInflow corresponding to the one carrier, the T2PInflow being a rate of transmission resource inflow into the bucket.

34. An access terminal as in claim 33, wherein the function is further operable when calculating to compute a result of a linear operator, the linear operator for determining an increase in ΔT2PInflow based on a current filtered reverse link pilot power of the one carrier and an average value of current filtered reverse link pilot powers in all the other plurality of carriers, to compute the ΔT2PInflow based at least on the result of the linear operator, and to add the computed ΔT2PInflow to a current T2PInflow corresponding to the bucket, the T2PInflow being a rate of transmission resource inflow into the bucket.

35. A computer program product embodied on a computer readable medium and comprising program instructions for directing at least one data processor that comprises part of an access terminal to perform an operation of determining whether information corresponding to one of a plurality of carriers indicates the one carrier is loaded or unloaded, wherein the plurality of carriers are used for transmission of a medium access control (MAC) flow by the access terminal over a reverse link, and to perform an operation of adjusting, in response to the determining operation, transmission resource allocation corresponding to the MAC flow for the one carrier, the adjusting operation being based at least in part on information corresponding to carrier loading for each of the plurality of carriers except the one carrier and on information corresponding to reverse link pilot power for each of the plurality of carriers.

36. A computer program product as in claim 35, wherein:
the operation of determining further comprises determining whether the information of carrier loading for the one carrier indicates the one carrier is loaded for at least one sub-frame relative to a current sub-frame for the MAC flow; and
the operation of adjusting further comprises, in response to the information of carrier loading for the one carrier indicating the one carrier is loaded, calculating ΔT2PInflow, an average transmission resource to be added to the bucket for the MAC flow at the current sub-frame, wherein calculating ΔT2PInflow is performed so that a decrease occurs for the transmission resource for the bucket at the current sub-frame.

37. A computer program product as in claim 36, wherein the operation of calculating further comprises the operations of:
computing a result of a linear operator, the linear operator for determining a decrease in ΔT2PInflow based on a sum of a current effective quick Reverse Activity Bit (RAB) value (QRAB) minus a constant for each of the plurality of carriers except the one carrier;
computing the ΔT2PInflow based at least on the result of the linear operator; and
adding the computed ΔT2PInflow to a current T2PInflow corresponding to the one carrier, the T2PInflow being a rate of transmission resource inflow into the bucket.

38. A computer program product as in claim 36, wherein the operation of calculating further comprises the operations of:
computing a result of the linear operator, the linear operator for determining a decrease in ΔT2PInflow based on a current filtered reverse link pilot power of the one carrier and an average value of current filtered reverse link pilot powers in all the other plurality of carriers;
computing the ΔT2PInflow based at least on the result of the linear operator; and
adding the computed ΔT2PInflow to a current T2PInflow corresponding to the bucket, the T2PInflow being a rate of transmission resource inflow into the bucket.

39. A computer program product as in claim 35, wherein:
the operation of determining further comprises determining whether the information of carrier loading for the one carrier indicates the one carrier is unloaded for at least one sub-frame relative to a current sub-frame for the MAC flow; and
the operation of adjusting further comprises, in response to the information of carrier loading for the one carrier indicating the one carrier is unloaded, calculating ΔT2PInflow, an average transmission resource to be added to the bucket for the MAC flow at the current sub-frame, wherein calculating ΔT2PInflow is performed so that an increase occurs for the transmission resource for the bucket at the current sub-frame.

40. A computer program product as in claim 39, wherein the operation of calculating further comprises the operations of:
computing a result of a linear operator, the linear operator for determining an increase in ΔT2PInflow based on a sum of a current effective quick Reverse Activity Bit (RAB) value (QRAB) plus a constant for each of the plurality of carriers except the one carrier;
computing the ΔT2PInflow based at least on the result of the linear operator; and
adding the computed ΔT2PInflow to a current T2PInflow corresponding to the one carrier, the T2PInflow being a rate of transmission resource inflow into the bucket.

41. A computer program product as in claim 39, wherein the operation of calculating further comprises the operations of:
computing a result of a linear operator, the linear operator for determining an increase in ΔT2PInflow based on a current filtered reverse link pilot power of the one carrier and an average value of current filtered reverse link pilot powers in all the other plurality of carriers;
computing the ΔT2PInflow based at least on the result of the linear operator; and
adding the computed ΔT2PInflow to a current T2PInflow corresponding to the bucket, the T2PInflow being a rate of transmission resource inflow into the bucket.

42. An access terminal, comprising means for determining whether information corresponding to one of a plurality of carriers indicates the one carrier is loaded or unloaded, wherein the plurality of carriers are used for transmission of a medium access control (MAC) flow by the access terminal over a reverse link, and comprising means responsive to the determination for adjusting transmission resource allocation corresponding to the MAC flow for the one carrier, the adjusting based at least in part on information corresponding to carrier loading for each of the plurality of carriers and on information corresponding to reverse link pilot power for each of the plurality of carriers.

43. An access terminal as in claim 42, wherein:
the means for determining further comprises means for determining whether the information of carrier loading for the one carrier indicates the one carrier is loaded for at least one sub-frame relative to a current sub-frame for the MAC flow; and
the means for adjusting further comprises means, responsive to the information of carrier loading for the one carrier indicating the one carrier is loaded, for calculating ΔT2PInflow, an average transmission resource to be added to the bucket for the MAC flow at the current sub-frame, using at least the following operations:
computing a first result of a first linear operator, the first linear operator for determining a decrease in ΔT2PInflow based on a sum of a current effective quick Reverse Activity Bit (RAB) value (QRAB) minus a constant for each of the plurality of carriers except the one carrier;
computing a second result of a second linear operator, the second linear operator for determining a decrease in ΔT2PInflow based on a current filtered reverse link pilot power of the one carrier and an average value of current filtered reverse link pilot powers in all the other plurality of carriers;
computing the ΔT2PInflow based at least on the first and second results; and
adding the computed ΔT2PInflow to a current T2PInflow corresponding to the one carrier, the T2PInflow being a rate of transmission resource inflow into the bucket.

44. An access terminal as in claim 42, wherein:
the means for determining further comprises means for determining whether the information of carrier loading for the one carrier indicates the one carrier is unloaded for at least one sub-frame relative to a current sub-frame for the MAC flow; and
the means for adjusting further comprises means, responsive to the information of carrier loading for the one carrier indicating the one carrier is unloaded, for calculating ΔT2PInflow, an average transmission resource to be added to the bucket for the MAC flow at the current sub-frame, using at least the following operations:
computing a first result of a first linear operator, the first linear operator for determining an increase in ΔT2PInflow based on a sum of a current effective quick Reverse Activity Bit (RAB) value (QRAB) plus a constant for each of the plurality of carriers except the one carrier;
computing a second result of a second linear operator, the second linear operator for determining an increase in ΔT2PInflow based on a current filtered reverse link pilot power of the one carrier and an average value of current filtered reverse link pilot powers in all the other plurality of carriers;
computing the ΔT2PInflow based at least on the first and second results; and
adding the computed ΔT2PInflow to a current T2PInflow corresponding to the one carrier, the T2PInflow being a rate of transmission resource inflow into the bucket.

45. An integrated circuit, the integrated circuit comprising a function operable to determine whether information corresponding to one of a plurality of carriers indicates the one carrier is loaded or unloaded, wherein the plurality of carriers are used for transmission of a medium access control (MAC) flow by the access terminal over a reverse link, the function also operable to adjust, responsive to the determination, transmission resource allocation corresponding to the MAC flow for the one carrier, the adjustment based at least in part on information corresponding to carrier loading for each of the plurality of carriers and on information corresponding to reverse link pilot power for each of the plurality of carriers.
